(19) United States
(12) Patent Application Publication
(10) Pub. No.: US 2013/0068373 A1
(43) Pub. Date: Mar. 21, 2013

(54) PASTE AND METHOD FOR CONNECTING ELECTRONIC COMPONENT TO SUBSTRATE

(71) Applicants: Michael SCHÄFER, Kunzell (DE); Wolfgang SCHMITT, Rodgau (DE); Albert HEILMANN, Alzenau (DE); Jens NACHREINER, Gelnhausen (DE)

(72) Inventors: Michael SCHÄFER, Kunzell (DE); Wolfgang SCHMITT, Rodgau (DE); Albert HEILMANN, Alzenau (DE); Jens NACHREINER, Gelnhausen (DE)

(73) Assignee: HERAEUS MATERIALS TECHNOLOGY GMBH & CO. KG, Hanau (DE)

(21) Appl. No.: 13/604,687

(22) Filed: Sep. 6, 2012

(30) Foreign Application Priority Data
Sep. 20, 2011 (EP) 11 007 634.6

(51) Int. Cl. C09J 11/06; B29C 65/48

(52) U.S. Cl. 156/89.16; 106/287.18

(57) ABSTRACT

A paste may be used to connect at least one electronic component to at least one substrate through contact regions, wherein at least one of the contact regions contains a non-noble metal. The paste contains (a) metal particles, (b) at least one activator that bears at least two carboxylic acid units in the molecule, and (c) a dispersion medium. A method for connecting at least one electronic component to at least one substrate through the contact regions includes steps of providing a substrate having a first contact region and an electronic component having a second contact region; providing the above paste; generating a structure, wherein the first contact region of the substrate contacts the second contact region of the electronic component through the paste; and sintering the structure while producing a module including at least the substrate and the electronic component connected to each other through the sintered paste.

### BACKGROUND OF THE INVENTION

The present invention relates to a paste for connecting an electronic component to a substrate and to a method for connecting an electronic component to a substrate.

In the field of power electronics, fastening electronic components on substrates is a special challenge. The mechanical stress that occurs during the operation of the terminal device requires the connection between the electronic component and the substrate to be of sufficient strength such that the electronic component does not detach from the substrate. Therefore, it has been common to use lead-containing solder pastes, which generate in the soldering process connecting layers showing high reliability with regard to their strength, for the connecting technology. Owing to the toxicity of lead and the associated health hazards, a suitable replacement for the lead-containing solder pastes is being sought. Discussed currently as an alternative to lead solders, lead-free solder pastes are well-suited for generating connecting layers between electronic components and substrates that have high strength. However, the solders have low melting points not much above the temperatures to which the electronic components are exposed in operation. As a result, the reliability of the strength of the connecting layers deteriorates significantly during operation of the electronic components.

High reliability of the strength of the connection between the electronic component and the substrate can be attained with numerous joining agents and joining methods. However, these often necessitate high process temperatures and high process pressures, which lead to damage to the parts to be connected and produce a high scrap rate in mass production.

This is the reason underlying the aim to lower the process temperatures and process pressures required for the joining methods. Adhesives are therefore used to connect the parts in some applications. Through the use of adhesives, connecting layers of high strength connecting electronic component and substrate can in some cases be attained. However, it is a disadvantage of adhesive technology that the contact sites between the electronic component and the substrate thus generated are often insufficient with regard to thermal conductivity and electrical conductivity.

To meet the requirements regarding reliability, thermal conductivity, and electrical conductivity of the joining site, it has been proposed for some time to connect electronic components and substrates through sintering (see, for example, German published patent application DE 10 2007 046 901 A1). Sintering technology is a very simple method for connecting components in stable manner. Using sintering methods, it is usually quite successful to connect electronic components to substrates, provided these each comprise a noble metal-containing contact region. However, it is often necessary to connect electronic components and substrates through at least one non-noble contact region. Using the conventional sintering methods, it is often not feasible to produce stable connections through the non-noble contact regions.

Moreover, it has been proposed earlier to use pastes based on nano-particles having a particle size of no more than 100 nm for connecting electronic components and substrates. However, the handling of nano-particles is associated with a health hazard and is therefore often avoided for reasons of occupational safety.

### BRIEF SUMMARY OF THE INVENTION

It was therefore one object of the invention to provide a paste that allows at least one electronic component to be connected to at least one substrate through contact regions, wherein at least one of the contact regions contains a non-noble metal. Preferably, the paste shall be used to create a connection between the electronic component and the substrate that ensures high reliability at temperatures to which the electronic component is exposed in operation. Moreover, the paste shall preferably also overcome other disadvantages known from the prior art.

It was also an object of the invention to provide a method for connecting at least one electronic component to at least one substrate through a contact region, wherein at least one of the contact regions contains a non-noble metal.

The objects are met according to the present invention by providing a paste containing (a) metal particles, (b) at least one activator that bears at least two carboxylic acid units in the molecule, and (c) a dispersion medium.

Moreover, the invention provides a method for connecting at least one electronic component to at least one substrate through contact regions, wherein at least one of the contact regions contains a non-noble metal, comprising the steps:

(i) providing a substrate having a first contact region and an electronic component having a second contact region, wherein at least one of the contact regions contains a non-noble metal;

(ii) providing a paste containing
(a) metal particles;
(b) at least one activator that bears at least two carboxylic acid units in the molecule; and
(c) a dispersion medium;

(iii) generating a structure, wherein the first contact region of the substrate contacts the second contact region of the electronic component through the paste; and

(iv) sintering the structure while producing a module that comprises at least the substrate and the electronic component connected to each other through the sintered paste.

The invention is based on the absolutely surprising insight that connecting electronic components to substrates through at least one contact region that comprises a non-noble metal, which has thus far been impossible, is enabled through sintering by means of a paste, provided the paste contains an activator that bears at least two carboxylic acid units in the molecule.

### DETAILED DESCRIPTION OF THE INVENTION

According to the invention, a paste is provided. There is no limitation to the definition of the term “paste.” However, it is preferred to understand paste to mean any dispersion that can be applied through common application techniques, as for example, printing techniques (for example screen printing or stencil printing), dispensing techniques, spraying techniques, pin transfer or dipping, and has sufficiently high viscosity and cohesion to enable the applied paste to be processed in subsequent steps.

The paste according to the invention contains (a) metal particles. Metal particles are preferably understood to mean particles that contain a metal. According to a preferred embodiment, the metal is selected from the group consisting of copper, silver, nickel, and aluminum. According to a particularly preferred embodiment, the metal is silver.

The metal can be present in the metal particles as pure metal, for example having a purity of at least 99% by weight, a purity of at least 99.9% by weight, a purity of at least 99.99% by weight, or a purity of at least 99.999% by weight. On the other hand, the metal particles can contain multiple metals just as well. It is also feasible for the metal particles to contain alloys or intermetallic phases made of multiple metals.

According to a preferred embodiment, the metal particles comprise as their main component an element selected from the group consisting of silver, copper, nickel, and aluminum. In the scope of the invention, main component is understood to mean the element of which a larger fraction is present in the metal particle of interest than of any other element that is present in the metal particle.

According to a particularly preferred embodiment, the metal particles are silver particles, copper particles, nickel particles, or aluminum particles. Optionally, the particles can be partly or fully oxidized at their surface. According to a particularly preferred embodiment, the metal particles are silver particles.

There is no limitation to the shape of the metal particles. Preferably, the metal particles take the shape of flakes, an ellipsoidal shape or a round shape. It is feasible just as well for the metal particles to be a mixture of multiple shapes.

According to a particularly preferred embodiment, the metal particles take the shape of flakes. The fraction of flakes in the embodiment preferably is at least 70% by weight, more preferably at least 80% by weight, even more preferably at least 90% by weight, and particularly preferably at least 99% by weight, relative to the total weight of the metal particles.

According to another preferred embodiment, the metal particles have a length ratio of more than 1.0, more preferably a length ratio of more than 1.2, even more preferably a length ratio of more than 1.5, and particularly preferably a length ratio of more than 2.0. Preferably, the metal particles have a length ratio of no more than 20, more preferably a length ratio of no more than 15, and even more preferably a length ratio of no more than 10. In this context, the length ratio shall be understood to mean the ratio of distance (a) extending through the widest place of the cross-section of a metal particle, to distance (b) extending through the widest place of the cross-section along a line perpendicular to distance (a). In this case, the cross-section is the section through a metal particle having the largest surface area. If a metal particle has, for example, a rectangular cross-section, the length ratio is the ratio of length to width of the cross-section. For example, a metal particle having a rectangular cross-section that has a length of 2 μm and a width of 1 μm has a length ratio of 2.

According to yet another preferred embodiment, the fraction of metal particles having a length ratio of more than 1.0, more preferably the fraction of metal particles having a length ratio of more than 1.2, and even more preferably the fraction of metal particles having a length ratio of more than 1.5 is at least 70% by weight, more preferably at least 80% by weight, and even more preferably at least 90% by weight, each relative to the total weight of the metal particles.

The metal particles present in the paste can have different particle size distributions.

According to a preferred embodiment, the mean particle size (the d50 value) of the metal particles is at least 500 nm, more preferably at least 650 nm, and even more preferably at least 1 μm. The mean particle size (the d50 value) preferably is no more than 20 μm, more preferably no more than 15 μm, and even more preferably no more than 10 μm. Accordingly, the mean particle size (the d50 value) preferably is in the range of 500 nm-20 μm, more preferably in the range of 650 nm-15 μm, and even more preferably in the range of 1-10 μm. Preferably, the mean particle size (the d50 value) is understood to mean a particle size that is not reached by 50% by volume of the metal particles and that is exceeded by 50% by volume of the metal particles.

According to another preferred embodiment, the particle size d10 (the d10 value) of the metal particles is at least 150 nm, more preferably at least 200 nm, and even more preferably at least 250 nm. The particle size d10 (the d10 value) preferably is no more than 5 μm, more preferably no more than 4 μm, and even more preferably no more than 3 μm. Accordingly, the particle size d10 (the d10 value) preferably is in the range of 150 nm-5 μm, more preferably in the range of 200 nm-4 μm, and even more preferably in the range of 250 nm-3 μm. Preferably, the particle size d10 (d10 value) is understood to mean a particle size that is not reached by 10% by volume of the metal particles and that is exceeded by 90% by volume of the metal particles.

According to yet another preferred embodiment, the particle size d90 (the d90 value) of the metal particles is at least 1.75 μm, more preferably at least 2 μm, and even more preferably at least 2.25 μm. The particle size d90 (the d90 value) preferably is no more than 100 μm, more preferably no more than 50 μm, and even more preferably no more than 25 μm. Accordingly, the particle size d90 (the d90 value) preferably is in the range of 1.75-100 μm, more preferably in the range of 2-50 μm, and even more preferably in the range of 2.25-25 μm. Preferably, the particle size d90 (d90 value) is understood to mean a particle size that is not reached by 90% by volume of the metal particles and that is exceeded by 10% by volume of the metal particles.

The preceding particle size specifications apply to analyses for determination of the particle size through the LALLS (Low Angle Laser Light Scattering) method according to ISO 13320 (2009). Preferably, the Mastersizer 2000 (Malvern Instruments Ltd., Worcestershire, United Kingdom) serves as the measuring instrument in this context. The measurement and the analysis are carried out under suitable conditions (for example: Standard: silver having a refractive index of 0.14, absorption of 3.99; dispersion medium: ethanol having a refractive index of 1.36; procedure: add 200 ml of ethanol to 0.5 grams of powder, sonicate the resulting suspension for 5 minutes, and then transfer an aliquot of the suspension for the measurement to the Hydro Accessory of the Mastersizer 2000; optical model for analysis: Mie theory).

Preferably, the metal particles have a specific surface according to BET (Brunauer, Emett, Teller) measurement in the range of 1-5 m²/g and more preferably in the range of 1-4 m²/g. Preferably, this BET measurement is carried out according to DIN ISO 9277:2003-05.

The metal particles can optionally just as well be present as a mixture of multiple fractions of metal particles. The fractions can differ, for example, by composition, shape or size of the metal particles.

Preferably, the fraction of metal particles is at least 50% by weight, more preferably at least 60% by weight, even more preferably at least 70% by weight, and particularly preferably at least 80% by weight, relative to the total weight of the paste. Preferably, the fraction of metal particles is no more than 95% by weight, more preferably no more than 93% by weight, and even more preferably no more than 90% by weight, relative to the total weight of the paste. Accordingly, the fraction of metal particles is preferably is in the range of 50-95% by weight, more preferably in the range of 60-93% by weight, and even more preferably in the range of 70-90% by weight, relative to the total weight of the paste.

The metal particles can comprise a coating. In the scope of the invention, a coating of metal particles is understood to mean a firmly adhering layer on the surface of the metal particles. Preferably, firmly adhering layer means that the layer does not detach from the metal particles simply under the effect of gravity.

The coating of the metal particles usually contains at least one coating compound. The at least one coating compound preferably is an organic compound.

Preferably, the coating compound is selected from the group consisting of saturated compounds, mono-unsaturated compounds, multi-unsaturated compounds, and mixtures thereof.

Preferably, the coating compound is selected from the group consisting of branched compounds, non-branched compounds, and mixtures thereof.

Preferably, the coating compound has 8-28, even more preferably 12-24, and particularly preferably 12-18, carbon atoms.

According to a preferred embodiment, the coating compound is selected from the group consisting of fatty acids, fatty acid salts, and fatty acid esters.

Conceivable fatty acid salts are preferably salts whose anionic component is the deprotonated fatty acid and whose cationic component is selected from the group consisting of ammonium ions, monoalkylammonium ions, dialkylammonium ions, trialkylammonium ions, lithium ions, sodium ions, potassium ions, copper ions, and aluminum ions.

Preferred fatty acid esters are derived from the corresponding fatty acids, wherein the hydroxyl groups of the carboxylic acid units are replaced by alkyl groups, in particular methyl groups, ethyl groups, propyl groups, or butyl groups.

According to a preferred embodiment, the at least one coating compound is selected from the group consisting of caprylic acid (octanoic acid), capric acid (decanoic acid), lauric acid (dodecanoic acid), myristic acid (tetradecanoic acid), palmitic acid (hexadecanoic acid), stearic acid (octadecanoic acid), mixtures thereof, as well as the corresponding esters and salts, and mixtures thereof.

According to a particularly preferred embodiment, the at least one coating compound is selected from the group consisting of lauric acid (dodecanoic acid), stearic acid (octadecanoic acid), sodium stearate, potassium stearate, aluminum stearate, copper stearate, sodium palmitate, and potassium palmitate.

The coated metal particles that are being used preferably can be commercially available. The corresponding coating compounds can be applied to the surface of the metal particles through a technique that is common in this field.

It is possible, for example, to slurry the coating compounds, in particular the stearates or palmitates mentioned above, in solvents and to triturate the slurried coating compounds together with the metal particles in ball mills. After trituration, the metal particles, which are by then coated with the coating compounds, are dried and then dust is removed.

Preferably, the fraction of the at least one coating compound selected from the group consisting of fatty acids, fatty acid salts, and fatty acid esters, relative to the total weight of the coating, is at least 80% by weight, more preferably at least 90% by weight, particularly preferably at least 95% by weight, even more particularly preferably at least 99% by weight, and in particular 100% by weight.

According to a preferred embodiment, the total fraction of coating compounds is 0.05-3% by weight, more preferably 0.07-2.5% by weight, and even more preferably 0.1-2.2% by weight, relative to the total weight of the coated metal particles.

The degree of coating, defined as the ratio of the mass of the coating compounds to the surface of the metal particles, preferably is 0.00005-0.03 g, more preferably 0.0001-0.02 g, and even more preferably 0.0005-0.02 g of coating compounds per square meter (m²) of surface of the metal particles.

Surprisingly, it was found that having a coating on the metal particles significantly improves the reliability of the strength of the connection between electronic component and substrate.

According to the invention, the paste also contains at least one activator (b). The activator bears at least two carboxylic acid units in the molecule. Accordingly, the activator can just as well bear more than two, more than three or more than four carboxylic acid units in the molecule. The position of the carboxylic acid units in the molecule is not limited. However, the carboxylic acid units of the activator are preferably situated in terminal position.

Moreover, it has proven to be advantageous for the carboxylic acid units of the activator to be connected to each other through no more than five carbon atoms, more preferably no more than four carbon atoms, even more preferably no more than three carbon atoms, particularly preferably no more than two carbon atoms, and even more particularly no more than one carbon atom. Furthermore, it is preferable for the carboxylic acid units of the activator to be connected to each other through at least one carbon atom. Determining the number of carbon atoms through which the carboxylic acid units of the activator are connected to each other, the carbon atoms of the carboxylic acid unit itself shall not be included in the calculation according to the scope of the invention. Accordingly, for example in the case of malonic acid (HOOCCH₂COOH), the carboxylic acid units are connected to each other through one carbon atom, whereas in the case of maleic acid (HOOC(CH)₂COOH) the carboxylic acid units are connected to each other through two carbon atoms.

According to a preferred embodiment, the activator comprises at least 2 carbon atoms and more preferably at least 3 carbon atoms. Preferably, the activator comprises no more than 18 carbon atoms, more preferably no more than 14 carbon atoms, even more preferably no more than 12 carbon atoms, particularly preferably no more than 10 carbon atoms, even more particularly preferably no more than 8 carbon atoms, and in particular no more than 6 carbon atoms. Accordingly, the activator preferably comprises 2-18 carbon atoms, more preferably 2-14 carbon atoms, even more preferably 2-12 carbon atoms, particularly preferably 2-10 carbon atoms, more particularly preferably 2-8 carbon atoms, in particular 2-6 carbon atoms or 3-6 carbon atoms.

The activator can be a saturated or an unsaturated compound. An unsaturated activator preferably comprises at least one carbon-carbon double bond in the molecule. Moreover, cis-isomers have proven to be particularly advantageous activators.

The activator can be a branched or a non-branched compound. The length, type, and position of the side chains of a branched activator are not subject to any limitation. Preferably, a branched activator comprises at least one side chain having a length of 1-8 carbon atoms. Usually, the side chain is an alkyl chain, which may be substituted, if applicable.

The activator can be an aromatic or an aliphatic compound. However, the activator is preferred to be an aliphatic compound.

Aside from the oxygen atoms present in the carboxylic acid units, the activator according to the invention can bear further hetero-atoms. However, the activator preferably contains no hetero-atoms aside from the oxygen atoms in the carboxylic acid units.

Preferably, the carboxylic acid units of the activator are present in non-protonated form in the paste. It can therefore be advantageous to select the dispersion medium appropriately for no dissociation of the carboxylic acid units to proceed.

It has proven to be advantageous in many cases for the activator to have a decomposition point below a temperature of 300° C., more preferably below a temperature of 270° C., even more preferably below a temperature of 240° C., and particularly preferably below a temperature of 200° C. In these cases, the decomposition point of the activator preferably is in the range of 100° C.-300° C., more preferably in the range of 110° C.-270° C., even more preferably in the range of 120° C.-240° C., and particularly preferably in the range of 130° C.-200° C.

Moreover, it has proven advantageous in many cases for the melting point of the activator to be at least 80° C., more preferably at least 90° C., and even more preferably at least 100° C. In these cases, it is preferable for the melting point to be no more than 200° C., more preferably no more than 180° C., and even more preferably no more than 160° C. Accordingly, preferably, the melting point of the activator is in the range of 80° C.-200° C., more preferably in the range of 90-180° C., and even more preferably in the range of 100° C.-160° C.

The activator can be present in non-complexed form. On the other hand, the activator can just as well be present in complexed form, preferably as a complex including a subgroup element from the periodic system of elements. If the activator is present in complexed form, this can, in particular, be a complexed dicarboxylic acid.

According to a preferred embodiment, the activator is selected from the group consisting of oxalic acid, malonic acid, succinic acid, glutaric acid, adipic acid, pimelic acid, cis-butenedioic acid (maleic acid), trans-butenedioc acid (fumaric acid), cis-2-pentenoic acid, trans-2-pentenoic acid, and dimethylmalonic acid.

According to a particularly preferred embodiment, the activator is selected from the group consisting of oxalic acid, malonic acid, maleic acid, and dimethylmalonic acid.

The fraction of activator preferably is at least 0.1% by weight, more preferably at least 0.3% by weight, even more preferably at least 0.5% by weight, particularly preferably at least 1% by weight, and even more particularly preferably at least 2% by weight, relative to the total weight of the paste. Preferably, the fraction of activator is no more than 30% by weight, more preferably no more than 20% by weight, even more preferably no more than 10% by weight, particularly preferably no more than 7% by weight, and even more particularly preferably no more than 5% by weight, relative to the total weight of the paste. Accordingly, the fraction of the activator is in the range of 0.1-30% by weight, more preferably in the range of 0.3-20% by weight, even more preferably in the range of 0.5-10% by weight, particularly preferably in the range of 1-7% by weight, and even more particularly preferably in the range of 2-5% by weight, relative to the total weight of the paste.

Moreover, the paste according to the invention contains a dispersion medium (c). It is preferable for the metal particles (a) to be dispersible in the dispersion medium (c). The at least one activator (b) can also be dispersible in the dispersion medium (c). However, it is feasible just as well that the activator (b) is soluble in the dispersion medium (c).

The dispersion medium can be a dispersion medium that is common in this field. Accordingly, the dispersion medium can contain one or more solvents.

Organic compounds, for example, are conceivable solvents in this context. The organic compounds preferably contain 5-50 carbon atoms, more preferably 8-32 carbon atoms, and even more preferably 18-32 carbon atoms. The organic compounds can be branched or non-branched. The organic compounds can just as well be cyclic compounds. The organic compounds can also be aliphatic or aromatic by nature. Moreover, the organic compounds that are used as solvents can be saturated or mono- or multi-unsaturated compounds.

The organic compounds can also comprise hetero-atoms, in particular oxygen atoms or nitrogen atoms. The hetero-atoms can be part of functional groups. Conceivable functional groups include, for example, carboxylic acid groups, ester groups, keto groups, aldehyde groups, hydroxyl groups, amino groups, amide groups, azo groups, imide groups, cyano groups or nitrile groups.

Accordingly, for example, α-terpineol ((R)-(+)-α-terpineol, (S)-(−)-α-terpineol or racemates), β-terpineol, γ-terpineol, δ-terpineol, mixtures of the preceding terpineols, N-methyl-2-pyrrolidone, ethylene glycol, dimethylacetamide, alcohols, in particular those that comprise a non-branched or branched chain having 5-9 carbon atoms, 1-hexanol, 1-octanol, 1-dodecanol, 1-tridecanol, 2-tridecanol, 3-tridecanol, 4-tridecanol, 5-tridecanol, 6-tridecanol, isotridecanol, dibasic esters (preferably dimethylesters of glutaric, adipic or succinic acid or mixtures thereof), glycerol, diethylene glycol, triethylene glycol or mixtures thereof can be used as solvent.

According to another preferred embodiment, the dispersion medium contains at least one aprotic solvent. It can also be advantageous that the fraction of the at least one aprotic solvent is at least 70% by weight, more preferably at least 80% by weight, even more preferably at least 90% by weight, particularly preferably at least 95% by weight, and even more particularly preferably at least 99% by weight, relative to the total weight of all components of the paste that are liquid at a temperature of 25° C. and a pressure of 1.1013 bar.

The aprotic solvent is preferably selected from the group consisting of aliphatic hydrocarbon compounds, carboxylic acid esters, and ethers.

According to a particularly preferred embodiment, the dispersion medium contains at least one aliphatic hydrocarbon compound. The aliphatic hydrocarbon compound preferably comprises 5-50 carbon atoms, more preferably 8-32 carbon atoms, and even more preferably 18-32 carbon atoms. Accordingly, the aliphatic hydrocarbon compound can just as well be a paraffin.

The fraction of the dispersion medium preferably is at least 5% by weight, more preferably at least 8% by weight, and even more preferably at least 10% by weight, relative to the total weight of the paste. Preferably, the fraction of the dispersion medium is no more than 40% by weight, more preferably no more than 30% by weight, even more preferably no more than 20% by weight, and particularly preferably no more than 15% by weight, relative to the overall weight of the paste. Accordingly, the fraction of the dispersion medium preferably is in the range of 5-40% by weight, more preferably in the range of 8-30% by weight, and even more preferably in the range of 10-20% by weight, relative to the total weight of the paste.

The paste according to the invention can optionally contain further substances aside from the metal particles (a), the at least one activator (b), and the dispersion medium (c). Conceivable further substances are diluents, thickeners, and stabilizers that are common in this field.

Preferably, the fraction of substances other than (a) the metal particles, (b) the at least one activator that bears at least two carboxylic acid units in the molecule, and (c) the dispersion medium is no more than 20% by weight, more preferably no more than 15% by weight, even more preferably no more than 10% by weight, particularly preferably no more than 5% by weight, even more particularly preferably no more than 3% by weight, and in particular no more than 1% by weight, relative to the total weight of the paste.

The paste according to the invention can be manufactured through means that are common in this field. The paste can be manufactured, for example, through mixing the metal particles (a), the at one activator (b) that bears two carboxylic acid units in the molecule, and the dispersion medium (c).

According to a particularly preferred embodiment, the paste is manufactured in multiple steps. In this context, the at least one activator (b) is triturated in a first step. Trituration can proceed in a mill and serve to improve the dispersibility of the activator in the dispersion medium (c).

The triturated activator (b) can then combined with the dispersion medium (c) in a second step. It is customary that a homogeneous suspension of the activator (b) in the dispersion medium (c) is produced in this step. In order to produce the homogeneous suspension, the mixture can be treated with a mixer, for example an Ultraturax mixer, if applicable.

And finally, the suspension from the second step can be combined with the metal particles (a) in a third step. Subsequently, the resulting mixture is optionally homogenized, for example manually. Subsequently, the mixture can be passed through a roller mill repeatedly and homogenized further, if needed. Then the resulting paste can be used for the intended use.

The paste according to the invention is preferably used for connecting at least one electronic component to at least one substrate. In this process, the at least one electronic component is preferably fastened on the substrate. The fastening is effected through sintering. In the scope of the invention, sintering is understood to mean connecting two or more components through heating without producing a liquid phase. Accordingly, sintering preferably produces a firmly bonded connection between the at least one electronic component and the substrate.

As common in this field, an electronic component is understood to be an object that can be part of an electronic arrangement. According to a preferred embodiment, electronic component is understood to mean a single component that cannot be disassembled further and can serve as a component of an electronic circuit. As a unit, the electronic component can optionally consist of multiple components. The electronic component can, for example, be an active component or a passive component. According to particular embodiments, the electronic component is used in high-power electronics. Preferably, the electronic component is selected from the group consisting of diodes (for example LEDs, light emitting diodes), transistors (for example IGBTs, insulated-gate bipolar transistors, bipolar transistors with insulated gate electrode), integrated circuits, semiconductor chips, bare chips (dies), resistors, sensors, capacitors, coils, and heat sinks.

Generally, substrate is understood to mean an object that can be connected to an electronic component. According to a preferred embodiment, the substrate is selected from the group consisting of lead frames, DCB substrates (direct-copper-bonded substrates), and ceramic substrates.

According to a preferred embodiment, the following pairs of electronic component and substrate are being connected to each other: LED/lead frame, LED/ceramic substrate, die/lead frame, die/ceramic substrate, die/DCB substrate, diode/lead frame, diode/ceramic substrate, diode/DCB substrate, IGBT/leadframe, IGBT/ceramic substrate, IGBT/DCB substrate, integrated circuit/leadframe, integrated circuit/ceramic substrate, integrated circuit/DCB substrate, sensor/lead frame, sensor/ceramic substrate, heat sink (preferably copper or aluminum heat sink)/DCB, heat sink (preferably copper or aluminum heat sink)/ceramic substrate, heat sink/lead frame, capacitor (preferably tantalum capacitor, more preferably in unenclosed condition)/leadframe.

According to another preferred embodiment, multiple electronic components can be connected to the substrate. Moreover, it can be preferred to arrange electronic components on opposite sides of the substrate.

However, both electronic component and substrate comprise at least one contact region. In the scope of the invention, contact region is understood to mean a region of the electronic component to which the substrate is contacted through the paste according to the invention or a region of the substrate to which the electronic component is contacted through the paste according to the invention. Accordingly, the contact region of the electronic component preferably comprises a contact surface that is covered by the substrate once the substrate is connected thereto. Likewise, the contact region of the substrate preferably comprises a contact surface that is covered by the electronic component once the electronic component is connected thereto. Preferably, the contact region of the electronic component has a volume that is defined by the contact surface of the contact region of the electronic component (defined by width and length of the contact surface) and a thickness of 50 nm. Likewise, the contact region of the substrate preferably has a volume that is defined by the contact surface of the contact region of the substrate (defined by width and length of the contact surface) and a thickness of 50 nm. The volume of the contact region of electronic component and substrate has a certain weight. The weight can be determined, for example, by removing the contact region through sputtering by means of Auger spectroscopy and then determining the weight of the removed region.

The contact region can be a region that is applied to the electronic component or to the substrate. For example, in many cases, a metallization is applied to a surface of an electronic component that is to be connected. The metallization can in many cases account for a thickness in the range of 100-400 nm. A metallization of this type or a region thereof can represent a contact region according to the invention.

On the other hand, the contact region can just as well be an integral component of the electronic component or of the substrate. For example, according to the invention, a lead frame made of copper can be used as substrate. Such lead frames can have a thickness in the range of several millimeters. In this case, a region of the lead frame, which does not necessarily have to be different from other regions of the lead frame in terms of substance or structure, can represent a contact region according to the invention.

At least one of the contact regions of electronic component and substrate contains at least one non-noble metal. According to a preferred embodiment, at least one of the contact regions of electronic component and substrate comprising a non-noble metal contains at least one element selected from the group consisting of (i) copper, aluminum, zinc, and nickel, (ii) alloys comprising at least one element selected from copper, aluminum, zinc, and nickel, and (iii) intermetallic phases comprising at least one element selected from copper, aluminum, zinc, and nickel.

The fraction of the at least one non-noble metal, for example of a non-noble metal selected from the group consisting of copper, aluminum, zinc, and nickel, is preferably at least 5% by weight, more preferably at least 7% by weight, even more preferably at least 10% by weight, particularly preferably at least 15% by weight, even more particularly preferably at least 50% by weight, and in particular at least 90% by weight, relative to the weight of the contact region comprising a non-noble metal.

Preferably, a non-noble metal, more preferably a non-noble metal selected from the group consisting of copper, aluminum, zinc, and nickel, is the main ingredient of the contact region. In the scope of the invention, main ingredient of the contact region is understood to mean the element of which a larger fraction is present in the contact region than of any other element that is present in the contact region.

In the scope of the invention, the contact region comprising a non-noble metal can also comprise other elements, including, in particular, noble metals.

If the contact region comprising a non-noble metal contains an alloy that comprises at least one element selected from copper, aluminum, zinc, and nickel, then the alloy can, for example, be an alloy that consists essentially of copper, nickel, zinc, and common impurities or an alloy that consists essentially of tin, gold, and common impurities.

In a first step of the method according to the invention, a substrate having a first contact region and an electronic component having a second contact region are provided, wherein at least one of the contact regions contains a non-noble metal. Accordingly, either the contact region of the substrate, the contact region of the electronic component or the contact region of the substrate and the contact region of the electronic component can contain a non-noble metal.

By definition, the substrate comprises a first contact region and the electronic component comprises a second contact region. Moreover, the substrate or the electronic component can optionally comprise further contact regions. If, for example, a lead frame is used as substrate, the lead frame usually contains a multitude of (adjacent) contact regions intended for connecting to a multitude of electronic components in order to form a subassembly.

In a next step of the method according to the invention, a paste according to the definition provided above is provided. Therefore, the paste contains (a) metal particles, (b) at least one activator that bears at least two carboxylic acid units in the molecule, and (c) a dispersion medium.

A structure is generated in a further step of the method according to the invention. The structure contains at least the substrate, the electronic component, and the paste. In this context, the paste is situated between the first contact region of the substrate and the second contact region of the electronic component. Accordingly, the first surface of the substrate contacts the second surface of the electronic component by means of the paste.

The structure can be generated, for example, by applying the paste to the contact surface of the first contact region of the substrate and placing the electronic component on the applied paste by the contact surface of the second contact region. Likewise, the structure can also be generated, for example, by applying the paste to the contact surface of the second contact region of the electronic component and placing the substrate on the applied paste by the contact surface of the first contact region. Applying the paste can preferably proceed by means of application techniques that are common in this field, for example by means of printing methods (for example screen printing or stencil printing), dispensing technique, spraying technique, pin transfer or dipping.

The distance between the first surface of the substrate and the second surface of the electronic component, which is determined essentially by the thickness of the paste, right after generating the structure, preferably is in the range of 20-200 μm, and more preferably in the range of 50-100 μm.

Once the structure is generated, it can optionally be dried. Preferably, the structure is dried at a temperature in the range of 80-200° C., and more preferably at a temperature in the range of 100-150° C. Drying preferably proceeds for a period of time of 2-20 minutes, and more preferably for a period of time of 5-10 minutes. If desired, drying can also proceed instead or in addition and preferably under the above-mentioned conditions while the structure is being generated, for example before placing the electronic component onto the paste applied to the substrate or before placing the substrate on the paste applied onto the electronic component.

In a further step of the method according to the invention, the structure containing the substrate, the electronic component, and the paste is subjected to sintering. Upon sintering, the metal particles present in the paste and at least part of the contact regions are baked together. The remaining components that are present in the paste are usually removed from the paste during this process, for example by evaporating them, optionally after undergoing chemical conversion. The sintering proceeds based on diffusion processes, wherein elements present in the metal particles of the paste diffuse into the contact regions and elements present in the contact regions diffuse into the intervening spaces formed by the metal particles of the paste. Due to the temperatures and diffusion rates predominating during this process, a stable firmly bonded connection is formed.

Preferably, the sintering of the structure is effected by heating to a temperature of at least 150° C., more preferably to a temperature of at least 175° C., and even more preferably to a temperature of at least 200° C. Preferably, the sintering of the structure is effected by heating to a temperature of no more than 350° C. and even more preferably to a temperature of no more than 300° C. Accordingly, the structure is heated preferably to a temperature in the range of 150° C.-350° C., more preferably to a temperature in the range of 150° C.-300° C., even preferably to a temperature in the range of 175° C.-300° C., and particularly preferably to a temperature in the range of 200° C.-300° C.

The heating preferably proceeds without the application of any process pressure, i.e. at a process pressure of 0 kbar, but can just as well be carried out at elevated process pressure, for example at a process pressure of 1 kbar or more.

The heating preferably proceeds for a period of time of 1-60 minutes, and more preferably for a period of time of 2-45 minutes.

There is no limitation with regard to the atmosphere, in which the heating is effected. However, preferably the heating is carried out in an atmosphere that contains oxygen.

The sintering is carried out in a suitable apparatus for sintering that is common in this field and in which, preferably, the above-mentioned process parameters can be set.

After the sintering, a module is obtained that comprises at least the substrate and the electronic component connected to each other through the sintered paste.

According to a particularly preferred embodiment, the method according to the invention for connecting at least one electronic component to at least one substrate is carried out through contact regions, wherein at least one of the contact regions contains copper as non-noble metal. It has proven to be particularly advantageous in this case to use a paste that contains (a) metal particles, (b) at least one compound selected from the group consisting of malonic acid, maleic acid, and oxalic acid, as activator, and (c) a dispersion medium.

According to a further particularly preferred embodiment, the method according to the invention for connecting at least one electronic component to at least one substrate is carried out through contact regions, wherein at least one of the contact regions contains nickel as non-noble metal. It has proven to be particularly advantageous in this case to use a paste that contains (a) metal particles, (b) at least one compound selected from the group consisting of dimethylmalonic acid and oxalic acid, as activator, and (c) a dispersion medium.

The invention is illustrated in the following based on examples that do not limit the scope of the invention.

### EXAMPLES

Pastes 1-3 and reference pastes 1-3 according to the invention were prepared as follows at a composition according to Table 1 below:

TABLE 1
Composition of pastes 1-3 and reference pastes 1-3.

| | | | | Refer- | Refer- | Refer- |
|---|---|---|---|---|---|---|
| | | | | ence | ence | ence |
| | Paste 1 | Paste 2 | Paste 3 | paste 1 | paste 2 | paste 3 |
| Silver | 85% by | 85% by | 85% by | 85% by | 85% by | 85% by |
| particles | weight | weight | weight | weight | weight | weight |
| Paraffin | 12% by | 12% by | 12% by | 12% by | 12% by | 12% by |
| | weight | weight | weight | weight | weight | weight |
| Activator: | | | | | | |
| Malonic | 3% by | — | — | — | — | — |
| acid | weight | | | | | |
| Maleic | — | 3% by | — | — | — | — |
| acid | | weight | | | | |
| Dimethyl- | — | — | 3% by | — | — | — |
| malonic | | | weight | | | |
| acid | | | | | | |
| Silver | — | — | — | 3% by | — | — |
| lactate | | | | weight | | |
| Propionic | — | — | — | — | 3% by | — |
| acid | | | | | weight | |
| Urea | — | — | — | — | — | 3% by |
| | | | | | | weight |

In six different samples (for pastes 1-3 and reference pastes 1-3), the corresponding activators were first fine-triturated in a coffee grinder and then added to the dispersion medium. An Ultraturax mixer was used to produce homogeneous suspensions from the mixtures. The homogeneous suspensions were then added to the silver powder. The resulting mixtures were first homogenized manually using a spatula, then passed three times over a roller mill and homogenized again to obtain pastes 1-3 and reference pastes 1-3.

Pastes 1-3 and reference pastes 1-3 were used to connect lead frames to semiconductor chips. Lead frames made of copper or nickel and semiconductor chips with silver metallization were used for this purpose.

Pastes 1-3 and reference pastes 1-3 were applied to the corresponding lead frames in six samples. Then the semiconductor chips were placed on the applied paste. The distance between the opposite surfaces of lead frame and semiconductor chip was 80 μm. The structure thus obtained was pre-dried for 5 minutes at a temperature of 150° C. Subsequently, the structure thus obtained was sintered without pressure at a temperature of 250° C.

After the sintering process, an analysis was performed to assess the presence of a connection between semiconductor chip and lead frame as well as the reliability of the connection. The results of this analysis are summarized in Table 2.

TABLE 2
Results of the tests using pastes 1-3 and reference pastes 1-3.

| | Non-noble | Connection between | Reliability |
|---|---|---|---|
| | metal of the | semiconductor chip | of the |
| | contact region | and lead frame | connection |
| Paste 1 | Copper | Stable connection | Very high |
| Paste 2 | Copper | Stable connection | Very high |
| Paste 3 | Nickel | Stable connection | Very high |
| Reference paste 1 | Copper | No connection, | — |
| | | semiconductor chip does | |
| | | not adhere to lead frame | |
| Reference paste 2 | Copper | No connection, | — |
| | | semiconductor chip does | |
| | | not adhere to lead frame | |
| Reference paste 3 | Nickel | No connection, | — |
| | | semiconductor chip does | |
| | | not adhere to lead frame | |

The tests show that a stable connection is formed only with pastes 1-3 according to the invention, but not when reference pastes 1-3 are used.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

1.-10. (canceled)

11. A paste comprising:
(a) metal particles;
(b) at least one activator having at least two carboxylic acid units in its molecule; and
(c) a dispersion medium.

12. The paste according to claim 11, wherein the metal particles comprise silver particles.

13. The paste according to claim 11, wherein the activator has a decomposition point in a range of 100-300° C.

14. The paste according to claim 11, wherein the activator is selected from the group consisting of dicarboxylic acids and complexed dicarboxylic acids.

15. The paste according to claim 14, wherein the activator is selected from the group consisting of malonic acid, maleic acid, dimethylmalonic acid, and oxalic acid.

16. The paste according to claim 11, wherein the dispersion medium contains an aliphatic hydrocarbon compound.

17. A method for connecting at least one electronic component to at least one substrate through contact regions, the method comprising the steps:
(i) providing a substrate having a first contact region and an electronic component having a second contact region, wherein at least one of the contact regions contains a non-noble metal;
(ii) providing a paste comprising:
(a) metal particles;
(b) at least one activator having at least two carboxylic acid units in its molecule; and
(c) a dispersion medium;
(iii) generating a structure, wherein the first contact region of the substrate contacts the second contact region of the electronic component through the paste; and
(iv) sintering the structure while producing a module comprising at least the substrate and the electronic component connected to each other through the sintered paste.

18. The method according to claim 17, wherein at least one of the contact regions is an integral component of the electronic component or of the substrate.

19. The method according to claim 17, wherein the non-noble metal comprises copper and the activator is selected from the group consisting of malonic acid, maleic acid, and oxalic acid.

20. The method according to claim 17, wherein the non-noble metal comprises nickel and the activator is selected from the group consisting of dimethylmalonic acid and oxalic acid.
